(19) United States
(12) Patent Application Publication
(10) Pub. No.: US 2010/0146239 A1
(43) Pub. Date: Jun. 10, 2010

(54) CONTINUOUS ADDRESS SPACE IN NON-VOLATILE-MEMORIES (NVM) USING EFFICIENT EMBEDDED MANAGEMENT OF ARRAY DEFICIENCIES

(75) Inventors: Amir GABAI, Modiin (IL); Yoav Yogev, Mazkeret Batia (IL); Dror Avni, Haifa (IL); Eli Lusky, Tel Aviv (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: Infinite Memories Ltd., Rosh Haain, IL (US)

(21) Appl. No.: 12/330,116

(22) Filed: Dec. 8, 2008

(51) Int. Cl. G06F 12/10; G06F 11/20

(52) U.S. Cl. 711/202; 714/5; 711/E12.058; 714/E11.084

(57) ABSTRACT

The invention provides a method of managing bad block in a data storage device having an OTP memory die in order to present a continues address space toward the user, by using some of the OTP memory space for the management and maintaining address replacement table. Fast and efficient programming and writing algorithms are presented.

### FIELD OF THE INVENTION

The present invention relates to Non-Volatile-Memory (NVM) devices and to methods of using said device, particularly to a methods of managing array deficiencies.

### BACKGROUND OF THE INVENTION

Non-Volatile-Memories (NVM) are extensively used in various portable applications, including mobile phones, music and video players, games, toys and other applications.

FIG. 1 depicts one such exemplary application of NVM, namely a removable storage device such as a Disk On Key (DOK). However, the current invention is not limited to this specific use.

FIG. 1 depicts a system 100 comprising a host 110 and a data storage device 120 as known in the art. Data storage devices such as data cards, USB sticks or other storage devices usually integrate NVM 130 and a controller 140 into a single package 120.

When connected to a host device 110, for example a personal or a laptop computer, communication between the data storage card and the host device commence. The controller 140 within the data storage device 120 manages data transfer between the host and the NVM 130 by serving as a gateway in both data transfer directions by writing to and reading from NVM 130. The data consists of user data and management data and files. Management files comprising addresses updates and files naming. The operating system that enables the communication between the host and the data storage device is DOS (Disk Operating System) based.

As known in the art, Host 110 may request to read information from data storage device 120. Host 110 is fitted with operating system capable of accessing external storage devices. It generally consists of Master Boot Record (MBR); Partition Boot Record (PBR); Folders information; and File Allocation Table (FAT). The MBR consist information regarding the data storage device including FAT location and size; and root directory location. Its location is always logic address 0 which is translated by the controller to a physical address in the memory die. Root directory is with constant table size, consisting 512 rows, each with a description of the files or folders existing in the disk. It includes name, size, first block location and type of file (file or directory).

Upon power-up, when connecting the memory card to the host or per user request to access the memory card, the MBR is addressed, the host generates a copy of the FAT in its memory and approaches to the root directory where information regarding the files is extracted (either located in the root folder itself, or more typically in a subfolder associated with the folder which appears in the root directory). Once the location of the first block of the requested file is identified, the rest of the blocks are sequentially pointed by the FAT. The FAT is owned by the controller and it uses logic addresses—the translation of the logic addresses to physical addresses is done by the controller that allocates both the data and the FAT in specific physical locations within the memory array.

In prior art, the controller manages the data access to the NVM die by page chunks, with size ranging between 512 B to 4 KB where NAND flash type memory is commonly used as the NVM incorporated in data storage devices. Typically to NAND flash memories, the array is not fully functional and some of the pages are defected and malfunction. As each page is characterized by unique address, the indexes associated with the defected pages are being kept in a dedicated area of the memory array. On power-up, the controller reads the information into its internal memory and uses it to avoid reading or writing to the defected locations.

A variety of controllers are available with different complexity, performance and cost. One of the main features characterizing these controllers is the internal memory capacity that allows handling stored information in the memory array, for example, conversion tables to indicate on the defected pages and their location. For low cost controllers, the internal memory space might be less than the minimum requirement to accommodate the maximum allowed number of bad blocks in typical NAND flash, commonly less than 2% of the memory array.

In methods of the art, in order to support field programming, the information associated with newly occurring defected blocks must be stored in a dedicated area before power-down. In standard NAND flash, this may be realized by writhing and re-writhing to a dedicated region in the memory array. The outcome of the above description is that after few programming sequences, it may be possible that the loaded data is stored at non-continuous addresses space.

Other types of NVM memories that may be combined with a dedicated controller as a system is NOR flash or alternatively mask ROM (Read Only Memory) OTP (One Time Programmable), featuring perfect die characteristics with no need for bad blocks treatment due to tight production tolerances. In such a case the requirements from the controller are less demanding, as the ability to access a non continuous address space memory is not required.

The limitations that are associated with NOR memories relates to it being with costly to produce compare to NAND flash and mask ROM OTP. Mask ROM OTP memories also suffer from various deficiencies relating to the lack of field programmability capability, the limited die density, being typically less than 64 KB, and the long turn-around time as the processing time in the fabrication facility is long, typically 4-8 weeks. Furthermore, design to product phase may be long and costly as design errors may result with the need to generate new set of masks.

Other types of OTP memory that overcome the limitations associated with the traditional mask ROM technology are NROM and Matrix technologies. NROM technology for example features field programmability capability, realizing much higher die density and may compact up to four time more bits per given die area by realizing the four per bit QUAD NROM technology.

In order to be compatible with NOR flash and mask ROM OTP controllers, NAND flash, NROM based memories and other types of memories that allow bad block occurrence, must present a continuous address space to its interface with the controller. Hence, realization of internal management of array deficiencies in NVM die, will relax the demand from the controller die.

U.S. Pat. No. 6,034,891; titled “Multi-state flash memory defect management”; to Norman, Robert; discloses a defect management system for use in multi-state flash memory device, which has shift register which maintains input data to be written in defective memory location serially.

U.S. Pat. No. 5,671,229; titled “Flash eeprom system with defect handling”; to Harari, Eliyahou, et. al.; discloses a computer system flash EEPROM memory system with extended life, which uses selective sector erasing, defective cell and sector remapping, and write cache circuit reducing faults.

United States Patent Application 20060084219; to Lusky.; et al.; entitled “Advanced NROM structure and method of fabrication”; discloses a method to enable manufacturing the dual memory NROM memory die.

### SUMMARY OF THE INVENTION

The present invention relates to an apparatus, system and method for achieving continues address space in Non-Volatile-Memories (NVM) to support functionality of these memories with simple controllers.

It is an aspect of the invention to allow the use of NROM OTP memory in application where mask ROM technology is used, taking advantage of the low cost, field programming and high capacity of NROM OTP.

It is another aspect of the invention to adopt an NROM based OTP and NAND flash memories to work with continues address space. In the embodiment of the invention, the NVM memory internal logic will manage defected blocks in order for the controller die to work with continues address space.

The present invention discus methods and structures of using NVM memories in general and One-Time-Programmable (OTP) memory devices in particular. More specifically, the present invention relates to a method of managing bad blocks internally by the memory die rather than the controller die in such a way that the controller will face a continues address space (bypassing memory “holes” due to bad block).

An aspect of the current invention relates to the method of bad block management during programming stage and redirection of the specific bad block address to a good block address that will replace the original block during all future access.

As a non limiting example, the invention discloses a system based on an OTP 4 bit-per-cell NROM array. As the 4 bits-per-cell memory is realized using two separated physically packets of charge located over both the transistor junctions, each charge packet can be modulated to address 4 different logic levels being [0,0]; [0,1]; [1,0]; and [1,1]. The memory cells are manufactured with an initial value stored level of [1,1] and can be programmed only in the following direction [1,1]→[0,1]→[0,0]→[1,0]. Once a bit is programmed to a higher value it cannot be erased to a lower value.

The NROM cell can also be programmed to a 2 bit-per-cell mode where it can store one of the following two values [1] and [0] per each physical bit. The value [1] in 2 bit-per-cell is physically the same as [1,1] of the 4 bit-per-cell mode (which is the native mode) and [0] is physically the same as [1,0] of the 4 bit-per-cell (which is the most programmed mode). Read access to a 2 bit-per-cell mode information will be faster and more reliable than a read access to 4 bit-per-cell information which holds more data per cell.

The access to the data in the NROM OTP array is in a page resolution (typically 512-4K Byte), furthermore the page can be reprogrammed with the restriction of the program direction mentioned above. Any attempt to program a bit already programmed with a higher value will cause no action on the specific cell.

An exemplary method of this invention is to use some of the data pages in the array as control pages to point to each block in the array. The unprogrammed, initial state (all [1]) of all the cells in the pointer will indicate that no redirection of the data block is needed and the original page should be accesses. A value different then the initial value will cause this block to redirect and access to the block address stated in the designated area instead of the defective block.

The controller issues program command to the NVM's user pages using continuous address space where the logic circuitry manages the bad blocks internally, and redirect the continuous addresses to a valid block only.

When the controller die submits a program command, pages are accessed continuously to the available addresses. In case the program command full to finish successfully, the logic circuitry of the memory die tags this block as a defective block and use a spare block to finalize the program command; typically all spare blocks are allocated at the end of the array. After programming the user data, the redirection information is updated into a redirection table.

During read access the memory die is submitted with a continuous address space where the logic circuitry addresses the read command to the target page according to the redirection table.

Access to the redirection table may result with longer read operation of the die. A remedy to this may be realized by using a Fast Access Memory (FAM) table, an additional table to the redirection table. The FAM comprises only the real bad block information and it is allocated in a fast access special memory area. The fast access area may consist of 1 bit per cell and the entries can be sorted by the block address. Under these circumstances, during read operation, the internal array logic searches the redirection information in a short amount of time and therefore reduces the latency of the read operation.

It is an aspect of the current invention to provide a method of programming a non volatile memories having several defective blocks comprising: when encountering a bad block during programming: assigning a replacement block for programming data intended to be programmed in said bad block; and presenting continues address space by embedded memory logic management.

In some embodiments, the method further comprising: updating a counter with the number of bad blocks when encountering a bad during programming.

In some embodiments, updating a counter comprises updating at least one bit in a non volatile memory.

In some embodiments, updating a counter comprises updating a single bit in a non volatile

In some embodiments, updating counter bits is conducted in a sequential order from LSB to MSB.

In some embodiments, the step of replacement block for programming data intended to be programmed in said bad block comprises: reading from said counter data indicative of number of bad blocks; assigning a replacement block by counting the number of blocks from the end of a dedicated region according to the number bad blocks indicated in said counter.

In some embodiments, the method further comprising: updating a redirection table with address of said assigned replacement block.

In some embodiments, updating redirection table is comprises changing a single word in said redirection table.

In some embodiments updating a word in said redirection table comprising addressing a word with index equal to bad block address, and updating said word content with the assigned spare redirected block address.

In some embodiments, for a user data memory of 64K blocks or less, said updated word length is 16 bits or more.

In some embodiments, for a user data memory of 128K blocks or less, said updated word length is 17 bits or more.

In some embodiments an un-updated word in said redirection table indicates a user data block that was not assigned a replacement block.

In some embodiments the method further comprising: updating Fast Access Memory (FAM) table, indicating for each user data block logic address with if a replacement block was assigned or not.

In some embodiments the FAM table associates a single bit with at least single block in the user's data section.

In some embodiments, bits in FAM table are having index indicating the block address, and the bit content indicates if the block is defected or not.

In some embodiments, updating FAM table is done by changing a single bit.

In some embodiments the method, assigning alternative spare block comprising: identifying a bad block while attempting and failing to program user data page; programming said user data page in the corresponding page in the assigned spare redirected block; and if said failing page is not the first page in the defected block, copying preceding pages already programmed from the bad block to the assigned spare block.

In some embodiments, copying preceding pages already programmed from the bad block to the assigned spare redirected block comprising: reading data from a page to be copied to logic; and writing the page data to the corresponding page in redirected block.

In some embodiments the method further comprising: reading data from a page to be copied to logic; loading said page data to data storage controller; verifying data content using ECC; and fixing detected errors if so required; writing data from said storage controller to logic; and writing the page data to the redirected block.

It is an aspect of the current invention to provide a method of programming a non volatile memories having several defective blocks comprising checking logic addresses in FAM table to find if the page to be programmed belong to defected block or not.

In some embodiments, if FAM table indicates that said logic address is associated with a defective block, a spare block is addressed by a redirection table.

It is an aspect of the current invention to provide a method of reading user data page in a continuous logical address space from a NVM having several defective blocks comprising: reading from a redirection table data indicative of addresses of redirected defective blocks.

In some embodiments the method further comprising: reading from Fast Access Memory (FAM) table data indicative if said logical address associated with a redirected block or not; and if FAM table data indicates that said logical address associated with a redirected block, reading from a redirection table data indicative of addresses of redirected defective blocks.

It is an aspect of the current invention to provide a non-volatile memory device capable of automatically handling defective cells and generating continuous address space comprising: a memory array comprising: user data region; and code region comprising: Fast Access Memory (FAM) table; counter table; and spare blocks region; and b) a logic circuit for writing and reading from the memory array region.

In some embodiments the user data region further comprises a redirection table.

In some embodiments the code region comprises a redirection table.

In some embodiments the user data part capable of high density data storage is capable of storing at least two bits per cell.

In some embodiments the user data part capable of high density data storage is capable of storing at least four bits per cell.

In some embodiments the spare block region is at least 1% of the total capacity of the user data region

In some embodiments the spare blocks region is located at the last functional address space.

In some embodiments the size of spare block is determent by the number of bad blocks.

In some embodiments the code data region has accessibility resolution of single bit.

In some embodiments the code data region comprising same cell structures as in user data region.

In some embodiments the code data region comprising of cells capable of storing one bit per cell.

In some embodiments the code data region comprising of cells capable of storing two bits per cell.

In some embodiments the code data region comprising cells having at least 50% wider cell structure than the user region cell's width.

In some embodiments the non-volatile memory is constructed from NROM array.

In some embodiments the non-volatile memory is constructed from OTP cells.

In some embodiments the non-volatile memory is constructed from NAND flash cells.

In some embodiments the device is monolithic.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1a depicts a system 100 comprising a host 110 and a Non-Volatile-Memory (NVM) data storage device 120 as known in the art.

FIG. 1b schematically depicts a system 800 comprising a host 110 connected to a data storage device 820 according to an exemplary embodiment of the current invention.

FIG. 2a depicts the physical memory arrangement inside a flash memory, for example the user's data section 860.

FIG. 2b schematically depicts the process of writing user data into user's data section 860 according to the preferred embodiment of the invention.

FIG. 3 schematically depicts Fast Access Memory (FAM) table 800 used for acceleration of read command according to an exemplary embodiment of the current invention

FIG. 4 schematically depicts the data structure of redirection table 400, showing m pages 410(0) to 410(m−1), each page comprising redirection lines 411(0) to 411 (255).

FIG. 5 schematically depicts the data format in a page 410 of the redirection table 400 according to an exemplary embodiment of the current invention.

FIG. 6 schematically depicts the use of a counter 510 within code memory section 850 according to an exemplary embodiment of the invention.

FIG. 7a schematically depicts flow chart 600a of the first stage of algorithm used to write user data page into user's data memory section 860 according to the exemplary method of the current invention.

FIG. 7b schematically depicts flow chart 600b of the second stage of algorithm used to write user data page into user's data memory section 860 according to the exemplary method of the current invention.

FIG. 8a schematically depicts an algorithm 670a for copying data from pages on a defective block to a redirected (spare) block location according to an exemplary embodiment of the current invention.

FIG. 8b schematically depicts an algorithm 670b for copying data from pages on a defective block to a redirected block location using ECC according to a preferred exemplary embodiment of the current invention.

FIG. 9 schematically depicts reading algorithm 700 according to an exemplary embodiment of the current invention of a NVM device such as device 830 which was programmed for example by an algorithm such as disclosed in FIGS. 7a and 7b.

FIG. 10 schematically depicts sorting algorithm 900 according to an exemplary embodiment of the current invention, ensuring that redirection table 400 and FAM table 800 will not be allocated to defective blocks.

### DESCRIPTION OF THE PREFERRED EMBODIMENTS

The present invention relates to an apparatus, system and method for managing files in Non-Volatile-Memory (NVM) based data storage device. In particularly, OTP memories are addressed.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale. For clarity, non-essential elements were omitted from some of the drawings.

According to one aspect of the current invention, the memory die comprises two different areas: data and code regions.

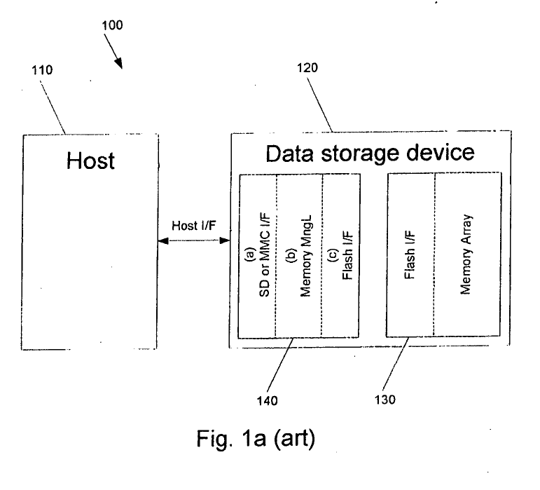

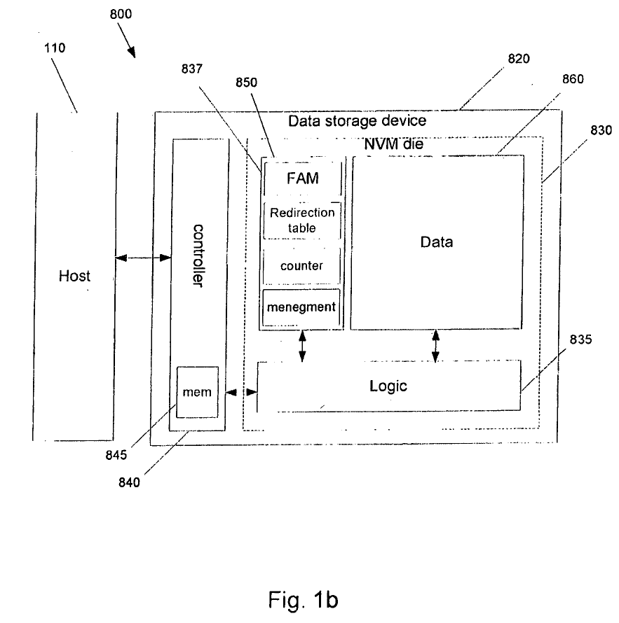

FIG. 1b schematically depicts a system 800 comprising a host 110 connected to a data storage device 820 according to an exemplary embodiment of the current invention. Data storage device 820 comprises NVM memory die 830; and a controller die 840 in a single package.

Controller 840 further comprises controller memory 845. Generally, controller memory 845 may comprises controller RAM memory (generally volatile memory) used for storing information used by the program executed by processor, and controller's ROM memory (non volatile) used for storing code of the program executed by the controller processor. Controller ROM memory may include parameters, indexes and pointers needed for the controller's operation and its interface with the NVM memory 830.

Controller 840 interfaces with memory logic 835 which write to and read from the memory cells.

According to an exemplary embodiment of the current invention the memory die 830 comprises of at least two dedicated different areas: User data memory section 860 and management code memory section 850. Preferably, data region 860 and code region 850 are made with same memory cells technology. Thus, the same sensing and driving circuits may be used for writing to and reading from both data region 860 and code region 850. However, optionally, data region 860 and code region 850 uses different architecture and logic arrangement to allow smaller blocks in code region 850 compared to data region 860. User data memory section 860 is data area and it is used for the user data storage. Information such as data files, music files or pictures are stored in this section.

To enable random access capability in code region with 1 bit or byte accessibility compared to 0.5K-4K byte accessibility in data region, NROM technology can be utilized. NROM technology incorporates virtual ground array architecture and enables both RAM (Random Access Memory) capability for code application and high density 4 bits per cell approach for data applications.

The code area may be for example with shorter word lines in code region 850 to allow faster reading and writing times due to lower capacitance of these lines. Additionally, shorter address used to specify cells in code region 850 may allow faster reading and writing times. Additionally or alternatively, sensing and/or driving parameters may be differently set to optimize writing to and reading from code region 850 and data region 860. Alternatively; different sensing and/or driving circuits may be used for the different memory regions.

The code area may be build with the same structure as the data area, however in this area writing and reading preferably uses 1 or 2 bit per cell method is used for faster reading cycles and better reliability. In a 4 bit per cell method the sensing scheme requires several sequences of read cycles until the data is read correctly. In a 1 or 2 bit per cell method read is done only once due to the large reliability margins.

Code area 850 may be used for bad blocks management as well as for file management information such as MBR, PBR, root directory and FAT. Bad block management region may incorporate redirection table 838 and Fast Access Memory (FAM) tables 837. Logic 835 further interfaces with FAM 837 and redirection table 838 where FAM 837 is configured to be read faster than user data memory 860 and optionally also faster than other regions in code data 850. However information capacity of fast memory 837 is limited.

According to an exemplary embodiment of the invention, code area 850 is preferably formed in dedicated mini-array within the die with memory size of 32K-256K byte; where the capacity of user data section 860 may be 64M-2 G byte or more.

According to an exemplary embodiment of the invention, minimal update chunk within the code area 850 is single byte or single bit while the minimal updated region within the data region 860 is page size of 0.5K-4K bytes

According to an exemplary embodiment of the invention, cell's structure of code region 850 and data region 860 is identical. According to this exemplary embodiment of the invention, cell's structure is preferably NROM cell, wherein:

One or two bits per cell may be stored in code region 850 for improved reliability where Single Level Cell (SLC) methods are used; while

Four bits per cell may be stored in the data region 860 where Multi Level Cell (MLC) methods are used.

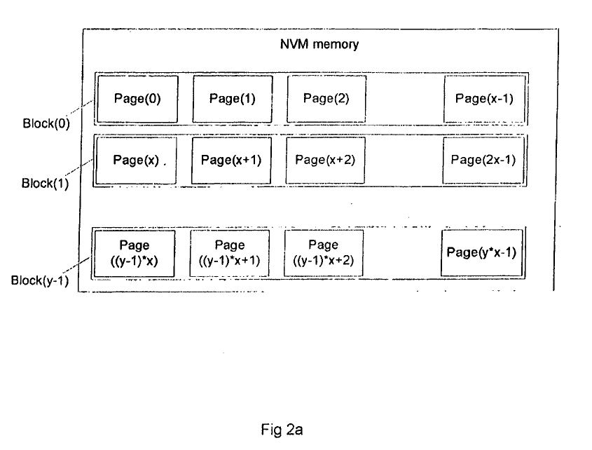

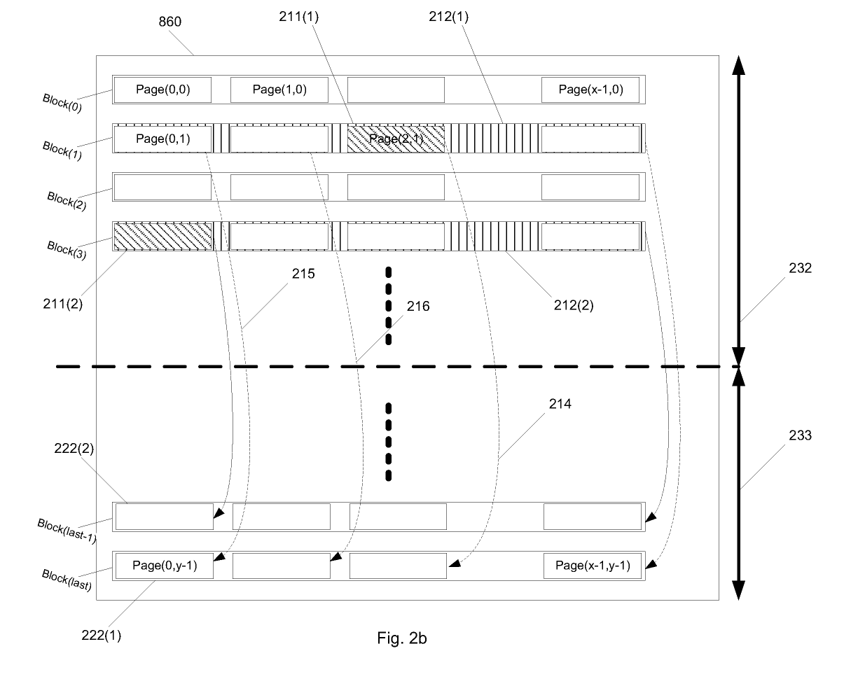

FIG. 2a depicts the physical memory arrangement inside a flash memory, for example the user's data section 860. Page is the basic memory chunk that is available for user access. The array is build out x*y pages arranged in a matrix of pages of x columns over y rows. Each row of pages is one block. Often, small portion of the memory array suffers from manufacturing defects and abnormal memory characteristics. When such a phenomena is detected, the whole block associated with the page in which the defected or abnormal behavior was detected is treated as a bad block.

FIG. 2b schematically depicts the process of writing user data into user's data section 860 according to the preferred embodiment of the invention. User's data may be written into the memory array page by page in original continuous address space 232, starting at page 0 in block 0, and progressing to next page till the last page in a block, than continuing to the first page in the next block. Generally, after a page was written, the proper working of the page is tested by an attempt to read the data from the cell and comparing the read data to the data that was written to it. If the two are identical, the page is working correctly.

In the exemplary embodiment of FIG. 2b, all the pages in the first block are working properly. However, the third page in the second block, page (2, 1) is the first page to be found defected. Thus, the page is tagged as bad page 211. Consequently, the entire second block, block (1), is tagged as first bad block 211(1).

A replacement page is then issued and written 214 to the last block namely page (2, y−1) in the spare blocks region 233. This block is used as the first substitution block 222(1). Preferably no more data is attempted to be written to the defected block 212(1) which is tagged as bad block and data already written to it is copied to the corresponding pages in the last block, block 222(1), that is: data from page (0,1) is copied 215 to page (0,y−1); data from page (1,1) is copied 216 to page (1,y−1); etc. More user's data is than written to the next page of the last block until the last block is completely written. Writing user's data is resumed at the first page in the next available block following the defective block.

Should a second page be found defective, the block preceding the first substitution block is used. In this way, the block before last 222(2), block y−2, substitutes the second defective block 211(2).

As user data is being written from the beginning of the array and more bad blocks are possibly found, substitution blocks are written from the end of the array until eventually the substitution blocks section 232 meets the data section 233 and the useful blocks in the array are all used up and no more user's data can be written.

The method of writing data according to the current invention guarantees that all the useful memory blocks would be utilized. Moreover, most of the user data is written to its intended locations. Only data that was attempted to be written into bad blocks is displaced and written into corresponding pages in a spare blocks region. If a spare block is found defected, it is treated as any other defected block: the data intended to it is written in the preceding block.

It is another object of the current invention to provide a method enable easy and fast access to the spare blocks during write and read commands.

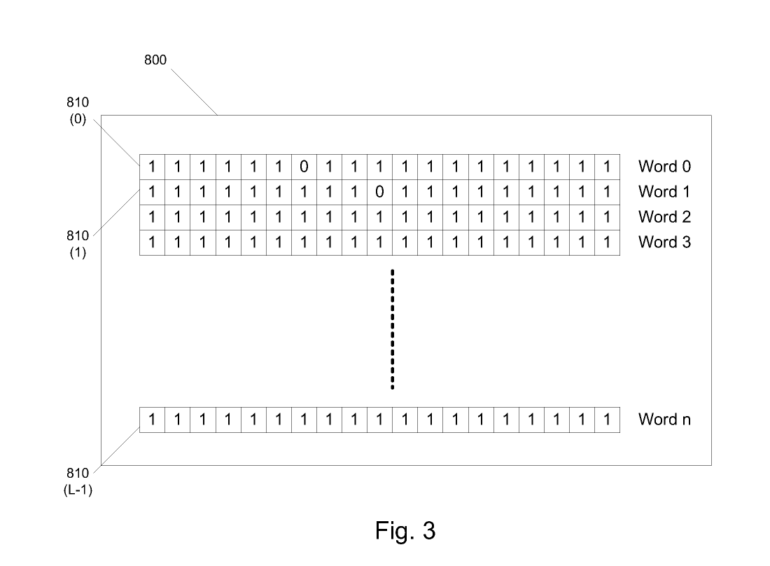

FIG. 3 schematically depicts Fast Access Memory (FAM) table 800 used for acceleration of read command according to an exemplary embodiment of the current invention. FAM table 800 consists of information indicating if a specific block was replaced or not. Naturally, this requires one bit to be associated with each block. In the depicted embodiment, the native state of the memory cells is state “1” and the bits 830 are associated with a replaced blocks are programmed to state “0”.
a. Since density of bad blocks is low, each bit in FAM table 800 may be associated with plurality of blocks, for example 2, 4, 8, or 16 blocks. Naturally, this reduces the size of FAM table 800. Preferably, FAM table 800 is stored in code region 850. Alternatively, it may be allocated in user data section 860. The choice of location of FAM table 800 depends if FAM table 800 is incrementally created. If so, FAM table 800 needs to be stored in code memory section 850 since it is updated one bit at a time whenever a bad block is discovered. However, if FAM table 800 is prepared in advance with no need for field programmability, the entire table may be programmed page by page.

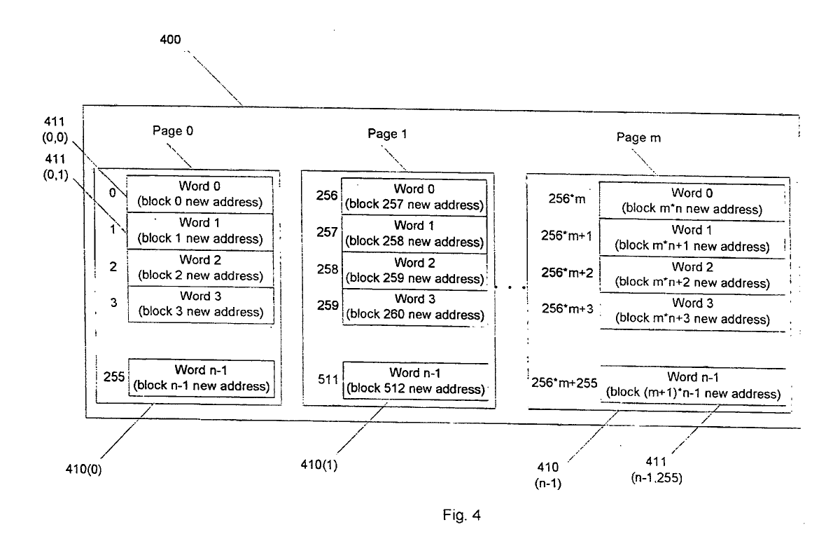

Upon detection of bad block in FAM table as depicted in FIG. 3, the redirection table, 400, shown in FIG. 4 is addressed. FIG. 4 schematically depicts the data structure of redirection table 400, showing n pages 410(0) to 410(m−1), each page comprising redirection lines 411(0) to 411(255).

Each word index in redirection table 400 represents a block of the user 860 data area while the content of each word points to the associated replacement block address:

word 0 on control page 0 represents block 0 of the array

word 1 on control page 0 represents block 1 of the array . . .

word (m-1)*256 on control page (m-1) represents block (m-1)*256 of the array

In this example, the redirection table is composed of pages 410, each may be composed of 256 words, 411(0), 411(1), . . . 411(255) with 16 bits per word. Up to 64K blocks in the array may be mapped using 16 bits words. The number of pages in the redirection table is determined by the total number of blocks and the number of blocks that are pointed by each page. Hence, the number of pages in such a case is set by the die partition; for a die with 64K blocks, 256 pages are required as 256 blocks are indicated by each page.

According to an aspect of the invention redirection table 400 is used for storing information regarding spare blocks. For each block in the continuous memory address space, there is information stating if the block location was changed in the replacement process during data writing, and if so—what is the address of the spare block. It should be noted that the number of spare blocks is small compare to the total number of blocks, typically 2%.

According to embodiment of the current invention, each word 411 in the redirection table 400 is associated with a specific block (good or bad) in the user region 860 where the index of the word relates to the block address and the content of the word relates to the redirected address; located in region 233 (FIG. 2b) if the block is defected.

It should be noted that data loading order need not be sequential from the beginning of the array 860. In fact, data may be written in random order, as long as enough rows are left at the end of the array to be used as replacement blocks. Replacement blocks are used chronologically starting at the array bottom. It is assumed that the file operating system is controlling and handling the block allocation for data writing, and it is an object of the invention to manage bad blocks and present to the operating system interrupted logic address space as if it was a continuous address space. Moreover, the methods according to the current invention are independent from higher-level data management methods which are assumed to operate at the host and the controller level and manage the logical locations, structure and order in which data is written to and read from the array.

It should be noted that often, a defective block is detected by trying and failing to program the first page. This is the case where the defect is in the lines leading to the block or other block related defects. Thus the number of times that data in pages which already been programmed needs to be moved is relatively small.

Table 400 is preferably stored in code memory section 850 of memory 830. Specifically, this is the case where the data is field programmable at different sequences. In that case, redirection table 400 needs to be updated line by line. If however, data content loading is to be carried out at single sequence, for example at the manufacturing or system assembly factory, the redirection table may be prepared in advance and the location may reside in user data region.

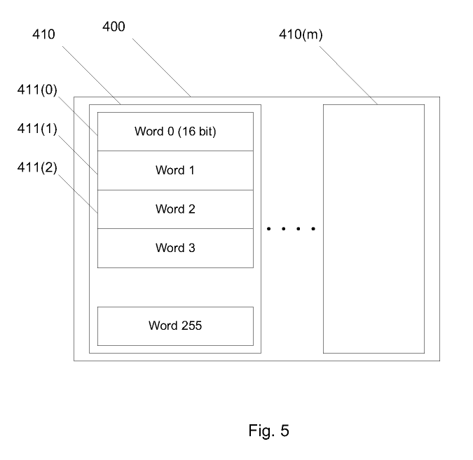

FIG. 5 schematically depicts the data format in a page 410 of the redirection table 400 according to an exemplary embodiment of the current invention.

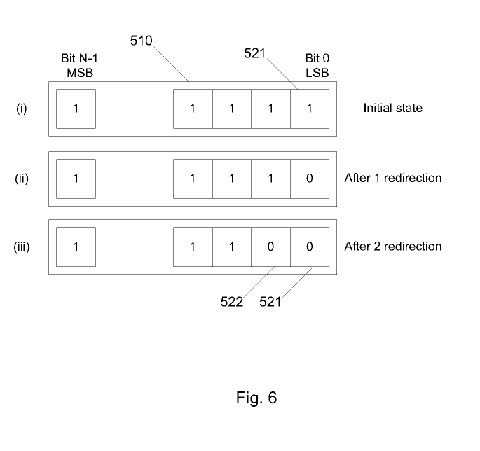

Table 400 comprises a plurality of pages 410, here seen as page 410 to last page 410(m). When program command is issued and failed, the redirection table replaces the bad block with a spare block. Yet, in order to trace the available spare blocks and those which already been used, a counter is used as depicted in FIG. 6. A counter is required in order to store the location of the last block that the system allocated for the redirection purposes. This block is located at m+1 blocks from the end of the array, wherein m is the number of bad blocks already encountered.
a. FIG. 6 schematically depicts the use of a counter 510 within code memory section 850. Depending on the cell technology, the cell may be programmed from its native state. In the depicted example, the native state is logical “1” and the cell may be programmed to logical state “0”. In FIG. 6(i), counter 510 represent the initial state of the counter wherein all bits are in state “1”, representing zero bad blocks already encounters. After the first bad block was encountered and replaced, the first (Least Significant Bit (LSB), bit 521 of counter 510 is programmed to state “0” as can be seen in FIG. 6(ii).

Each time a bad block is encountered, another bit is programmed as can be seen in FIG. 6(iii) showing the LSB 521 and the next bit 522 in state “0”, representing the numerical value of two redirected blocks. The memory space allocated to counter 510, namely N bits, needs to be large enough to accommodate the maximum number of bad blocks that may be found in user's data section 860. It should be noted that the non-volatile nature of counter 510 is used to ensure that this number may be recovered on power-up of the device. Thus, on each power up, the number of programmed bits in the counter 510 needs to be counted once.

Alternatively, the number of bad blocks already encountered may be stored in a non-volatile re-programmable memory location or register if one available, for example within controller memory 845.

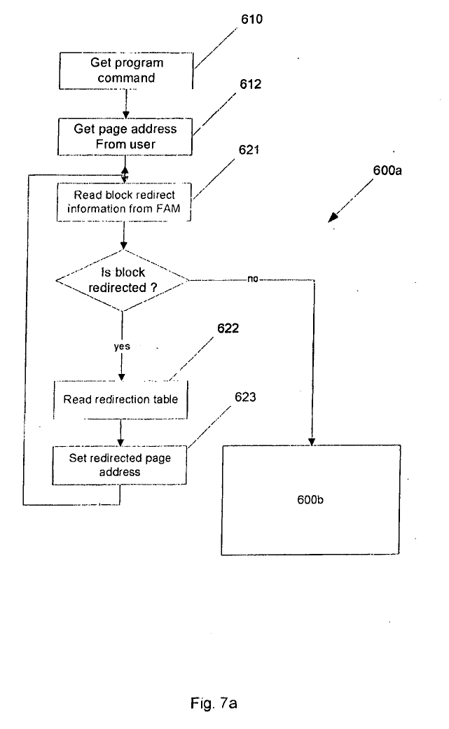

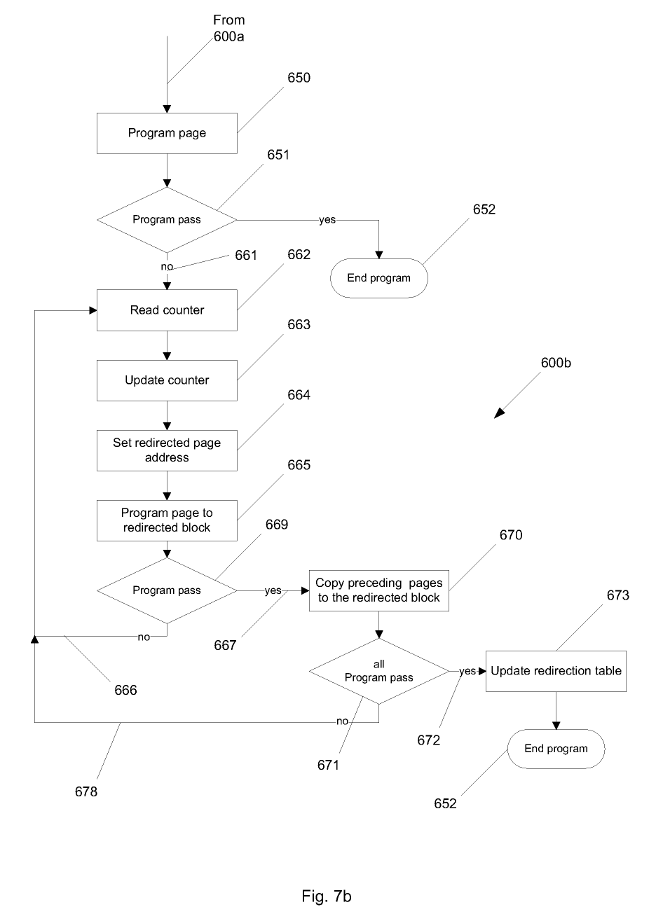

FIG. 7a schematically depicts flow chart 600a of the first stage of algorithm used to write user data page into user's data memory section 860 according to the exemplary method of the current invention.

When the die memory logic 835 receives a command 610 to write data to a page, it receives the data and the address 612 to which the data is intended to be written. FAM 621 is first addressed and if required redirection table 622 is than accessed and the exact location of the page to be written is traced 623. The higher-level management system is unaware that a block was found defective as the data is loaded to a continuous logic address space. Once a valid block address was found, page data is programmed as depicted by flow chart 600b of the second stage of algorithm depicted in FIG. 7b.

FIG. 7b schematically depicts flow chart 600b of the second stage of algorithm used to write user data page into user's data memory section 860 according to the exemplary method of the current invention.

At the second stage 600b, an attempt is made to program the data 650 into the page. Integrity of the programmed data is tested 651 by reading the data from the page and comparing the read data to the written data. If the read and written data are identical, the page programming is completed 652. Next page can be started according to 600a and 600b.

However, if the page is found defective 661, address of new assigned replacement block is read 662 from counter 510. Counter 510 is updated 663 and the replacement block address is set 664. Attempt is then made 665 to program the data into the corresponding page in the redirected block. Programming is verified 669, and if the attempt fulls 666, the next spare block is issued. If the programming is successful 667, the redirected block is presumed to be defect free.

If the page that was programmed is the first page in the block, page programming ends 652. Sequential data programming will resume on the second page of the redirected block. If the programmed page is not the first, attempt is made 670 to copy the data in all the preceding pages, which presumably were already programmed on the now defective block as depicted in FIG. 2b. If copying of any of the preceding pages fulls 678, a new spare block is chosen and the process re-starts by attempting to write the page data that failed at step 661.

Preferably, if copying 670 is successful 672, redirection table is updated 673 and the page programming is completed 652. Sequential data programming will resume on the next page of the redirected block. This is preferably done because step 664 is updating the logic internal register with the redirection page address, and step 673 is writing the page address into the redirection table.

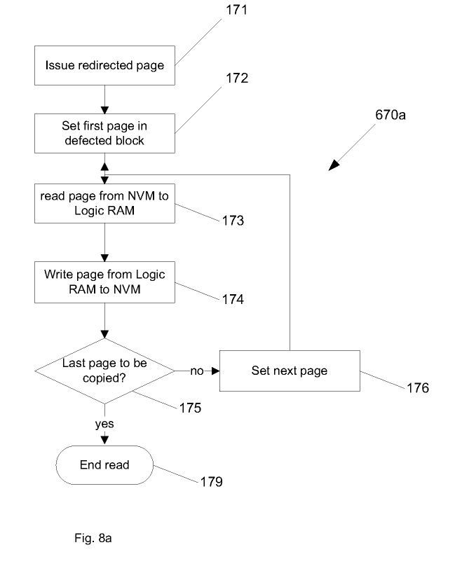

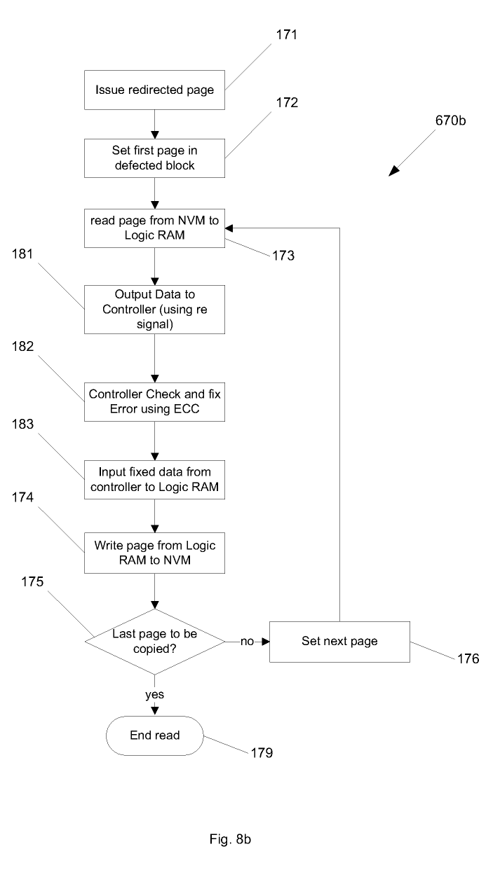

FIG. 8a schematically depicts an algorithm 670a for copying data from pages on a defective block to a redirected (spare) block according to an exemplary embodiment of the current invention. As depicted in step 670 in FIG. 7b, if a defective page is detected on a block and the page is not the first page on that block, data from the preceding pages on that defective blocks are preferably copied to the redirected block.

According to the exemplary of the current invention, once the defective block is identified and a redirected blocked is issued 171, the address of the first page in the defected block is set 172 and data from the page is read from user's memory 860 to RAM within logic 835. Page data is than written from the RAM within logic 835 to the redirected block in user's memory 860. The page number is tested 175 to see if the last page to be copied (the page before the page that was found to be defective) was reached. If so—the copy process is completed 179. If not, the address of the next page to be copied is set 176 and the copying process is repeated 173.

FIG. 8b schematically depicts an algorithm 670b for copying data from pages on a defective block to a redirected block location using ECC according to a preferred exemplary embodiment of the current invention. It should be noted that both writing and reading NVMs are prone to errors. The controller 840 is preferably configured to detect and correct such mistakes using Error Code Correction (ECC) methods.

According to the preferred of the current invention, once the defective block is identified and redirected page is issued 171, the address of the first page in the block is set 172 and data from the page is read from user's memory 860 to RAM within logic 835. Page data is transferred 181 to controller 840 that checks and correct the data using ECC 182. The corrected data is then returned 183 to the logic RAM. Page data is than written from the RAM within logic 835 to the redirected block in user's memory 860.

The page number is tested 175 to see if the last page to be copied (the page before the page that was found to be defective) was reached. If so—the copy process is completed 179. If no, the address of the next page to be copied is set 176 and the entire process is repeated.

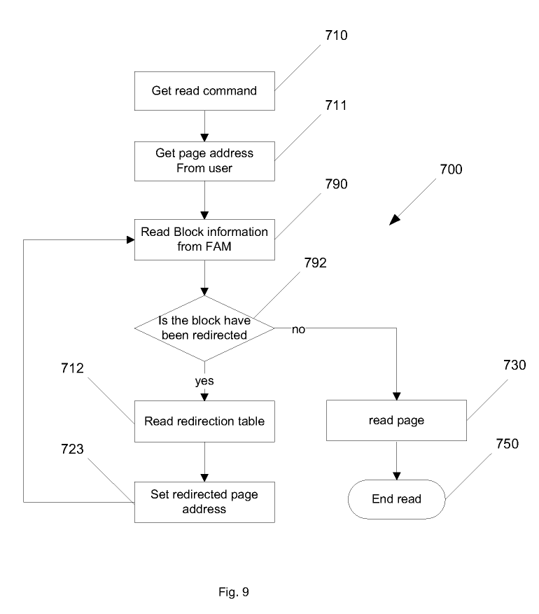

FIG. 9 schematically depicts reading algorithm 700 according to an exemplary embodiment of the current invention of NVM device such as device 830 which was programmed by an algorithm such as disclosed in FIGS. 7a and 7b according to an exemplary embodiment of the current invention.

It should be noted that optionally reading is done after programming of the device is completed due to programming of all the available memory space or all the needed data, and the device is locked to prevent additional data programming. Alternatively, data can be read in between data programming stages.

Data reading is initiated by a read command 710 from the host or internally from the controller. Address 711 of page to be read is obtained or computed by controller 840. The obtained address is then tested to check redirection status by first addressing FAM table 790 and redirection table 712 if required.

If the page is not on a defective block, and was not redirected, the data is read from the page 730 and page reading is completed 750. If the page was found to be on a redirected block, block address is set to the redirected block 723 as appears in the redirection table 400 and read block information 790 and subsequent steps are repeated to verify that the redirected block was not defective and was not redirected too.

Note, FAM table could have been avoided and redirection table could have been built dynamically having a raw dedicated for each bad block with the original and the redirection block addresses. This alternative approach may save some die area avoiding the need to associate the full extent of spare block capacity and allowing a possible use of this region as std. user region rather than replacement.

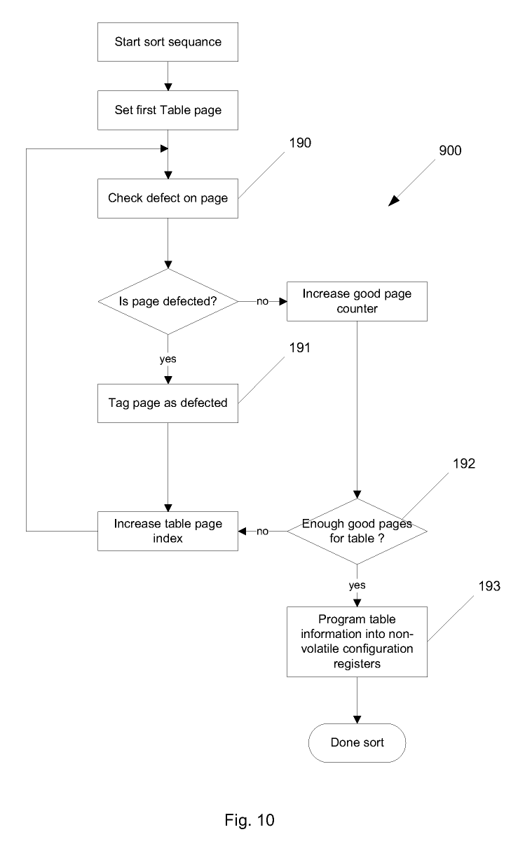

FIG. 10 schematically depicts sorting algorithm 900 according to an exemplary embodiment of the current invention, ensuring that redirection table 400 and FAM table 800 will not be allocated to defective blocks.

Redirecting the locations of redirection information tables may slow down both writing and more so reading process as these tables are frequently used during reading. In some cases, reading and or writing process may become unstable if redirection tables are redirected themselves.

Sorting algorithm 900 is preferably performed during device testing at the manufacturing plant. Sorting algorithm is preferably checks 190 one page after another for defects. Defective pages and optionally blocks are tagged 191 and are barred from being part of the memory space available for the redirection tables. Sorting is completed when enough good pages or blocks are identified 192. Addresses of good pages (or blocks) for the tables are programmed into non-volatile registers used during initialization of the NVM device when it is powered up or connected to host. Optionally, sorting continues until enough continuous addresses are located for the tables. Note, in OTP memories this step is limited as program operation can't be carried out as it is a single event. Yet, other tests are possible, for example, checking that these WL are not shorted.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method of programming non volatile memory having several defective blocks comprising:
when encountering a bad block during programming:
a) assigning a replacement block for programming data intended to be programmed in said bad block; and
b) presenting continues address space by embedded memory logic management.

2. The method of claim 1 and further comprising:
updating a counter with the number of bad blocks when encountering a bad block during programming.

3. The method of claim 2 wherein updating a counter comprises:
updating at least one bit in a non volatile memory.

4. The method of claim 2 wherein updating a counter comprises updating a single bit in a non volatile memory.

5. The method of claim 4 wherein updating the counter bits is conducted in a sequential order from LSB to MSB.

6. The method of claim 2 wherein the step of assigning a replacement block for programming data intended to be programmed in said bad block comprises:
reading from said counter data indicative of number of bad blocks; and
assigning a replacement block by counting the number of blocks from the end of a dedicated spare blocks region according to the number of bad blocks indicated in said counter.

7. The method of claim 1 and further comprising:
updating a redirection table with data indicative of the address of said assigned replacement block.

8. The method of claim 7 wherein updating redirection table comprises:
changing a single word in said redirection table.

9. The method of claim 8 wherein updating a word in said redirection table comprising: addressing a word with index equal to bad block address, and updating said word content with the assigned redirected block address.

10. The method of claim 9 wherein, for a user data memory of 64K blocks or less, said updated word length is 16 bits or more.

11. The method of claim 9 wherein, for a user data memory of 128K blocks or less, said updated word length is 17 bits or more.

12. The method of claim 8 wherein un-updated word in said redirection table indicates a user data block that was not assigned a replacement block.

13. The method of claim 1 and further comprising:
updating Fast Access Memory (FAM) table, indicating for each user data block logic address—if a replacement block was assigned or not.

14. The method of claim 13 wherein FAM table associates a single bit with at least single block in the user's data section.

15. The method of claim 13 wherein bits in FAM table are having index indicating the block address, and wherein the bit content indicates if the block has been redirected or not.

16. The method of claim 13 wherein updating FAM table is done by changing a single bit.

17. The method according to claim 1 wherein assigning alternative spare block comprising:
identifying a bad block while attempting and failing to program user data page;
programming said user data page in the corresponding page in the assigned redirected block; and
if said failing page is not the first page in the defected block, copying preceding pages already programmed in the bad block, from said bad block to the assigned redirected block.

18. The method according to claim 17 wherein copying preceding pages already programmed from the bad block to the assigned redirected block comprising:
reading data from a page to be copied to logic; and
writing the page data to the corresponding page in redirected block.

19. The method according to claim 18 and further comprising:
reading data from a page to be copied to logic;
loading said page data to data storage controller;
verifying data content using Error Correction Code (ECC), and fixing detected errors using ECC if so required;
writing data from said storage controller to said logic; and
writing the page data to said redirected block.

20. A method of programming non volatile memory having several defective blocks comprising:
checking logic addresses in FAM table to find if the page to be programmed belong to defected block or to a non-defective block.

21. The method of claim 20 wherein, if FAM table indicates that said logic address is associated with a defective block—reading address of redirected block from a redirection table.

22. A method of reading user data page, in a continuous logical address space NVM, having several defective blocks, comprising:
using embedded memory logic management, reading from a redirection table, data indicative of actual address of redirected blocks; and
presenting continues address space by embedded memory logic management.

23. The method of claim 22 and further comprising:
reading from Fast Access Memory (FAM) table data indicative if said logical address is associated with a redirected block; and
if FAM table data indicates that said logical address is associated with a redirected block—reading from a redirection table data indicative of address of said redirected block.

24. A non-volatile memory device capable of automatically handling defective cells and generating continuous address space comprising:
a memory array comprising:
uer data region; and
code region comprising:
Fast Access Memory (FAM) table;
counter table; and
spare blocks region; and
logic circuit for writing and reading from the memory array region.

25. The device of claim 24 wherein user data region further comprises a redirection table.

26. The device of claim 24 wherein the code region comprises a redirection table.

27. The device of claim 24 wherein the user data region capable of high density data storage is capable of storing at least two bits per cell.

28. The device of claim 27 wherein the user data region capable of high density data storage is capable of storing at least four bits per cell.

29. The device of claim 24 wherein the spare block region is at least 1% of the total capacity of the user data region.

30. The device of claim 24 wherein the spare blocks region is located at the last functional address space.

31. The device of claim 24 wherein the size of spare block region is determent by the number of bad blocks.

32. The device of claim 24 wherein the code data region has accessibility resolution of single bit.

33. The device of claim 24 wherein the code data region comprising same cell structures as in user data region.

34. The device of claim 24 wherein the code data region comprising of cells capable of storing one bit per cell.

35. The device of claim 24 wherein the code data region comprising of cells capable of storing two bits per cell.

36. The device of claim 24 wherein the code data region comprising cells having at least 50% wider cell structure than the user region cell's width.

37. The device of claim 24 wherein the non-volatile memory is constructed from NROM array.

38. The device of claim 24 wherein the non-volatile memory is constructed from OTP cells.

39. The device of claim 24 wherein the non-volatile memory is constructed from NAND flash cells.

40. The device of claim 24 wherein said device is monolithic.
